(19) United States
(12) Patent Application Publication
(10) Pub. No.: US 2026/0205686 A1
(43) Pub. Date: Jul. 16, 2026

(54) IMAGE CAPTURING APPARATUS THAT CONTROLS FUNCTION BASED ON INFORMATION ON CONNECTED POWER SUPPLY APPARATUS, CONTROL METHOD OF IMAGE CAPTURING APPARATUS, AND STORAGE MEDIUM

(71) Applicant: CANON KABUSHIKI KAISHA, Tokyo (JP)

(72) Inventors: HIKARU TAKAHASHI, Kanagawa (JP); YASUHITO KIGURE, Tokyo (JP)

(21) Appl. No.: 19/429,442

(22) Filed: Dec. 22, 2025

(30) Foreign Application Priority Data
Jan. 10, 2025 (JP) 2025-004338

(51) Int. Cl. H04N 23/65; G03B 13/36; H04N 23/55; H04N 23/63; H04N 23/667

(52) U.S. Cl. CPC H04N 23/651; G03B 13/36; H04N 23/55; H04N 23/631; H04N 23/667

(57) ABSTRACT

An image capturing apparatus connectable to a power supply apparatus, comprising: one or more memories storing instructions; and one or more processors configured to execute the instructions to: disable an autofocus function and enable a manual focus assist function for assisting confirmation of a focusing state at a time of manual focus adjustment, based on information on the power supply apparatus.

### BACKGROUND

### Field of the Technology

The present disclosure relates to an image capturing apparatus, a control method of the image capturing apparatus, and a storage medium.

### Description of the Related Art

An image capturing apparatus has power consumption fluctuating depending on the setting of the image capturing apparatus and peripheral equipment to be connected to the image capturing apparatus. There is a case where the supply capability of the power supply that drives the image capturing apparatus is insufficient due to fluctuation in the power consumption. In a case where the supply capability of the power supply is insufficient, the image capturing apparatus generally performs function restriction. The function restriction is an operation of restricting some functions of the image capturing apparatus to suppress power consumption. For example, since a motor that drives a lens apparatus has large power consumption, the image capturing apparatus reduces power supply to the motor. Japanese Patent Laid-Open No. 2000-171875 discloses a technique of restricting an operation of a lens apparatus in order to reduce power consumption of the lens apparatus in a case where sufficient power cannot be secured from a power supply.

However, when a function regarding the operation of the lens apparatus, for example, an autofocus (AF) function is restricted, there is a problem that operability of the image capturing apparatus is deteriorated.

### SUMMARY

The present disclosure has been made in view of the above problem, and provides a technique for improving usability.

According to one aspect of the present disclosure, there is provided an image capturing apparatus connectable to a power supply apparatus, comprising: one or more memories storing instructions; and one or more processors configured to execute the instructions to: disable an autofocus function and enable a manual focus assist function for assisting confirmation of a focusing state at a time of manual focus adjustment, based on information on the power supply apparatus.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a block diagram for describing an example of components of an image capturing apparatus.

FIG. 2 is a block diagram for describing details of an example of components of an image capturing apparatus according to a first embodiment.

FIGS. 3A and 3B are a flowchart showing a procedure of processing to be executed by the image capturing apparatus according to the first embodiment.

FIG. 4 is a block diagram for describing an example of components of an image capturing apparatus according to a second embodiment.

FIGS. 5A and 5B are a flowchart showing a procedure of processing to be executed by the image capturing apparatus according to the second embodiment.

FIG. 6 is an example of a UI to be displayed on a display unit in order to cause a user to determine MF assist function setting to be enabled at the time of function restriction in the second embodiment.

FIG. 7 is a block diagram for describing an example of components of an image capturing apparatus according to a third embodiment.

FIGS. 8A and 8B are a flowchart showing a procedure of processing to be executed by the image capturing apparatus according to the third embodiment.

FIG. 9 is a schematic view illustrating an example of data to be stored in a function restriction time setting storage unit in a fourth embodiment.

FIGS. 10A and 10B are a flowchart showing a procedure of processing to be executed by the image capturing apparatus according to the fourth embodiment.

FIG. 11 is an explanatory view of a focus guide function according to one embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

### Configuration of Image Capturing Apparatus

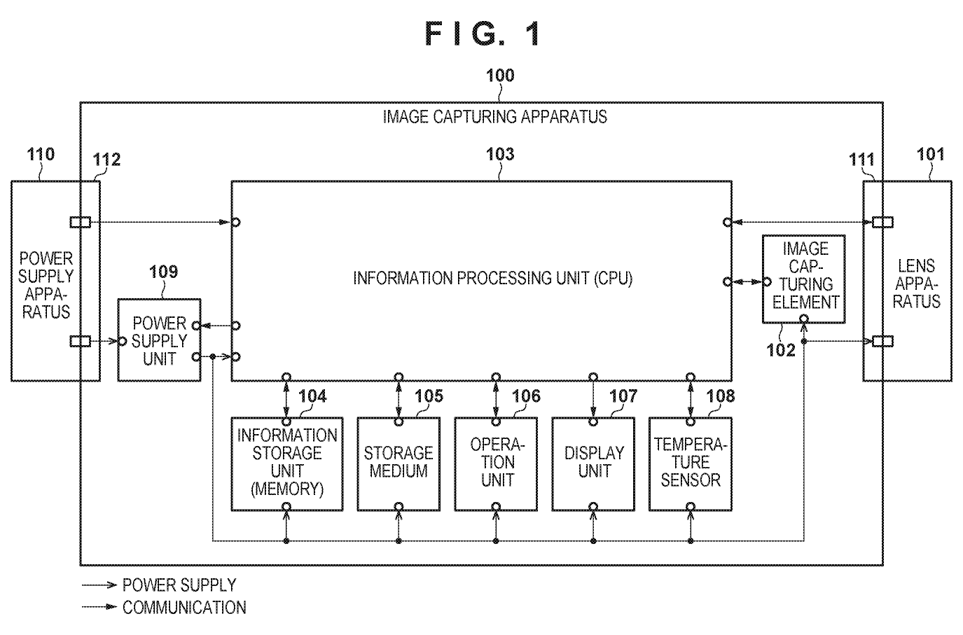

FIG. 1 is a block diagram for describing an example of components of an image capturing apparatus. An image capturing apparatus 100 is an apparatus operable as a digital camera or a digital video camera. The image capturing apparatus 100 may be a computer apparatus such as a smartphone, a tablet, an industrial camera, or a medical camera. The image capturing apparatus 100 is connectable to a power supply apparatus 110 and a lens apparatus 101.

The lens apparatus 101 is connected to the image capturing apparatus 100 via a lens apparatus connection unit 111, and forms an optical image of a subject on an image capturing surface of an image capturing element 102. The lens apparatus connection unit 111 includes a terminal for performing power supply and communication between the image capturing apparatus 100 and the lens apparatus 101, and electrically connects the image capturing apparatus 100 and the lens apparatus 101. The image capturing element 102 generates image data from the optical image formed on the image capturing surface. An information processing unit 103 is, for example, one or more CPUs, and performs predetermined image processing and predetermined encoding processing, thereby processing the image data generated by the image capturing element 102. The image data processed by the information processing unit 103 is recorded in a storage medium 105 and displayed on a display unit 107. Furthermore, the information processing unit 103 reads and executes a program stored in an information storage unit 104, thereby controlling each component of the image capturing apparatus 100.

The information storage unit 104 stores a program for controlling each component of the image capturing apparatus 100 and various data to be used in the information processing unit 103. For example, power consumption information for each operation mode, operation mode information, image data for notifying the user of a state of the image capturing apparatus 100, and the like are stored in the information storage unit 104. The storage medium 105 is a storage medium (e.g., SD card) that stores the image data encoded by the information processing unit 103. An operation unit 106 is a user interface (UI) with which a user operates the image capturing apparatus 100.

The display unit 107 performs display for confirmation of an image to be captured, display for reproduction confirmation of a captured image, and display of an operation mode and the like of the image capturing apparatus 100. A temperature sensor 108 is, for example, a thermistor, is connected to the information processing unit 103, and detects the temperature of each component. The information processing unit 103 acquires the temperature detected by the temperature sensor 108, and calculates a temperature margin until operation stop based on a difference between the operation upper limit temperature stored in advance in the information storage unit 104 and the detected temperature.

A power supply unit 109 is a circuit that converts a power supply voltage supplied from the power supply apparatus 110 into an appropriate voltage to supply power to each component of the image capturing apparatus 100. The power supply apparatus 110 is connected to the image capturing apparatus 100 via a power supply apparatus connection unit 112, and performs power supply to the power supply unit 109. The power supply apparatus connection unit 112 includes a terminal for performing power supply and communication between the image capturing apparatus 100 and the power supply apparatus 110, and electrically connects the image capturing apparatus 100 and the power supply apparatus 110.

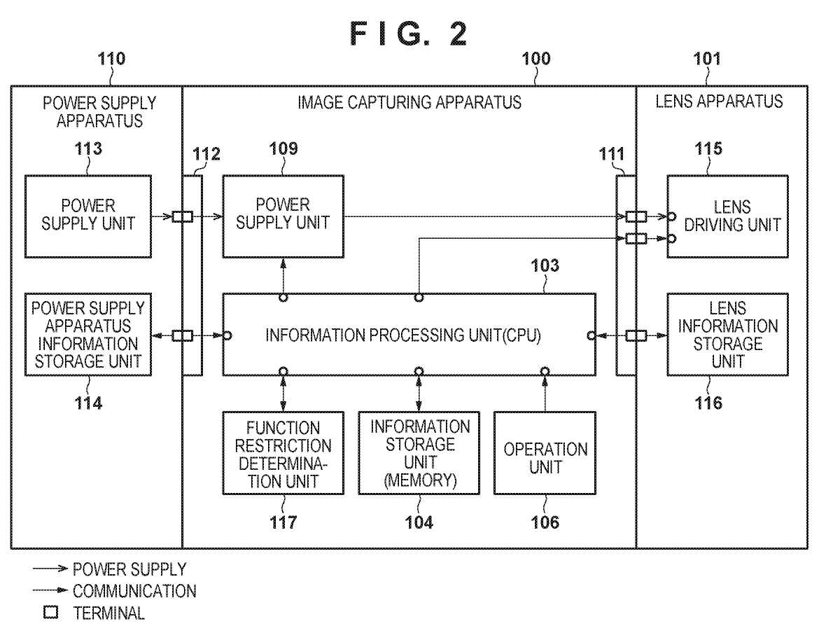

Subsequently, FIG. 2 is a block diagram in which the components illustrated in FIG. 1 are organized in order to describe the operation of the image capturing apparatus 100 according to the first embodiment. Specifically, for the sake of description, some of the components of the image capturing apparatus 100 are excerpted, and the components specific to the present embodiment are embodied in the drawing. A power feed unit 113 is, for example, a lithium ion battery, and supplies power to the power supply unit 109. A power supply apparatus information storage unit 114 stores information (e.g., a model number, a suppliable power value, and the like) regarding supply power of the power supply apparatus 110. The power supply apparatus information storage unit 114 can transmit information regarding supply power of the power supply apparatus 110 to the information processing unit 103.

A lens driving unit 115 is, for example, a motor, and is used to move the focusing lens. The lens driving unit 115 can receive a control signal (e.g., the number of rotations of the motor) from the information processing unit 103 to control the focusing operation. A lens information storage unit 116 stores information (e.g., a model number, a power consumption, and the like) regarding power consumption of the lens apparatus 101. The lens information storage unit 116 can transmit information regarding power consumption of the lens apparatus 101 to the information processing unit 103.

A function restriction determination unit 117 is, for example, one or more CPUs, and may be implemented in dedicated hardware or may be implemented as a part of the function of the information processing unit 103. The function restriction determination unit 117 receives information regarding the supply power of the power supply apparatus 110 and information regarding the power consumption of the lens apparatus 101 from the information processing unit 103 to determine necessity of function restriction. The function restriction determination unit 117 transmits a determination result to the information processing unit 103.

### Processing

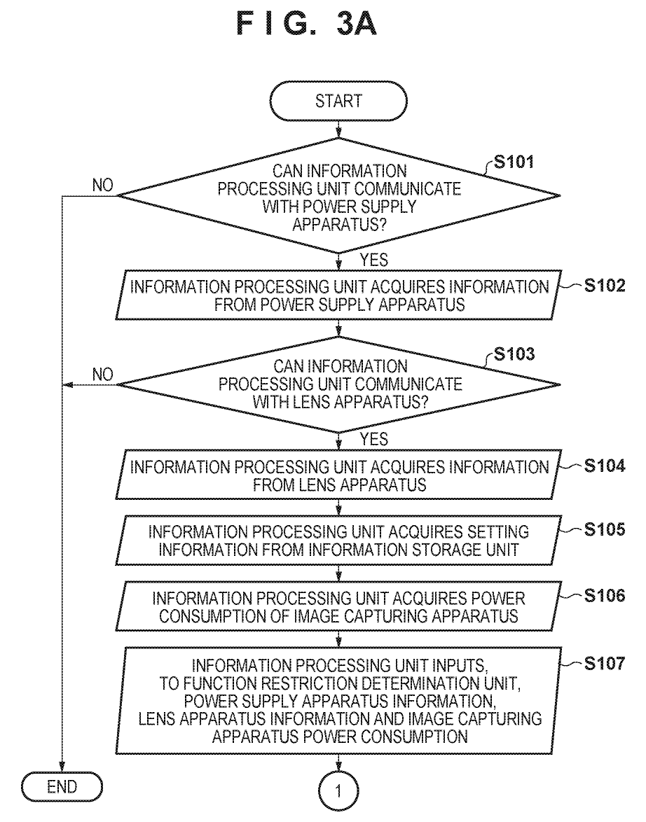

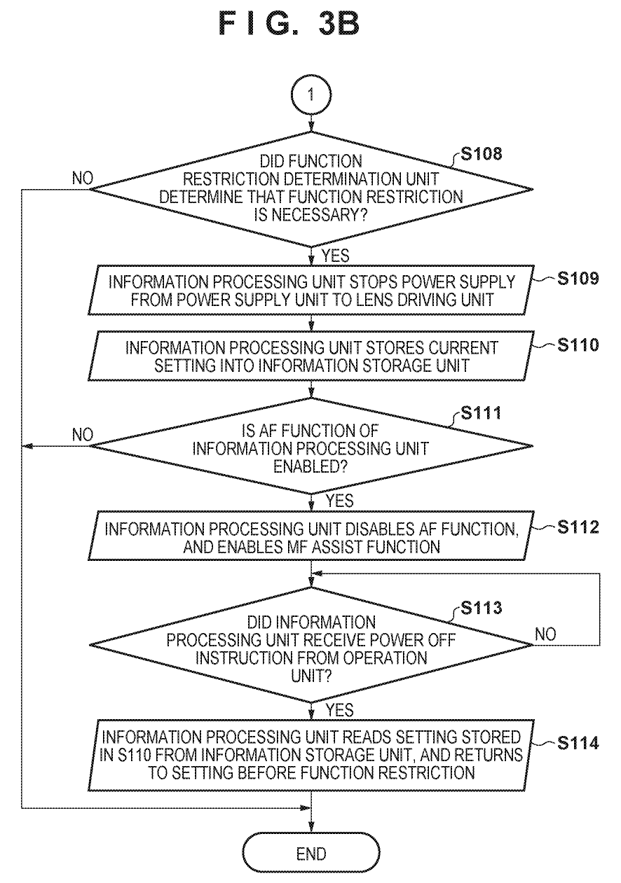

Next, the procedure of the processing to be executed by the image capturing apparatus 100 according to the first embodiment will be described with reference to the flowchart of FIGS. 3A and 3B. The image capturing apparatus 100 in the first embodiment is controlled by the information processing unit 103. It is assumed that at the start of the present flowchart, the image capturing apparatus 100 is connected to the power supply apparatus 110 and the lens apparatus 101.

In S101, the information processing unit 103 determines whether or not communication with the power supply apparatus 110 is possible. In a case where the determination result of the present step is Yes, the process proceeds to S102. In a case where the determination result of the present step is No, the process ends. In S102, the information processing unit 103 acquires information on the suppliable power value and/or the model number from the power supply apparatus 110. After completion of S102, the process proceeds to S103.

In S103, the information processing unit 103 determines whether or not communication with the lens apparatus 101 is possible. In a case where the determination result of the present step is Yes, the process proceeds to S104. In a case where the determination result of the present step is No, the process ends. In S104, the information processing unit 103 acquires information on the power consumption and/or the model number from the lens apparatus 101. In S105, the information processing unit 103 acquires setting information on the image capturing apparatus 100 from the information storage unit 104.

In S106, the information processing unit 103 acquires information on the power consumption of the image capturing apparatus 100 alone not including the lens apparatus 101. For this power consumption, a predetermined value (e.g., assumed maximum power consumption) is used in the present flow, but a variable value corresponding to the setting of the image capturing apparatus 100 may be used. In S107, the information processing unit 103 inputs, to the function restriction determination unit 117, information on the suppliable power value of the power supply apparatus 110, the power consumption of the lens apparatus 101, and the power consumption of the image capturing apparatus 100.

In S108, the function restriction determination unit 117 determines whether or not function restriction of the image capturing apparatus 100 is necessary based on the information on the power supply apparatus 110 (the suppliable power value and/or the model number), the information on the lens apparatus 101 (the power consumption and/or the model number), and the information on the image capturing apparatus 100 (the power consumption and/or the model number). In the determination processing, it is determined whether or not an inequality "S - P > 0" is satisfied, for example, in a case where the sum of the power consumption of the image capturing apparatus 100 and the lens apparatus 101 is S and the suppliable power value of the power supply apparatus 110 is P. In a case where this inequality is satisfied, it is determined that the function restriction is necessary (Yes in S108), and in a case where it is not satisfied, it is determined that the function restriction is unnecessary (No in S108). In a case where the determination result of the present step is Yes, the process proceeds to S109. In a case where the determination result of the present step is No, the process ends. Note that a table describing the necessity of function restriction corresponding to the combination of the model numbers of the power supply apparatus 110, the lens apparatus 101, and the image capturing apparatus 100 may be held in advance, and the necessity of function restriction may be determined from the model number information.

In S109, the information processing unit 103 stops the power supply from the power supply unit 109 to the lens apparatus 101. This can stop the drive of the lens apparatus 101.

In S110, the information processing unit 103 stores the current setting of the image capturing apparatus 100 into the information storage unit 104. In S111, the information processing unit 103 determines whether an AF function of the image capturing apparatus 100 is enabled or disabled. In a case where the determination result of the present step is Yes, the process proceeds to S112. In a case where the determination result of the present step is No, the process ends.

In S112, the information processing unit 103 disables the AF function of the image capturing apparatus 100, and enables the MF assist function. At this time, the MF assist function may be automatically enabled, or the user may select whether to enable or disable the MF assist function. For example, a confirmation prompt as to whether to enable the manual focus assist function may be displayed to enable selection by the user. In this case, in a case where the user selects to enable the MF assist function, control is performed so as to enable the MF assist function. The MF assist function is, for example, a peaking function that highlights a contour of a focusing position, and is a function for assisting a focus adjustment operation. In other words, the MF assist function is a function for assisting confirmation of a focusing state at the time of manual focus adjustment.

In S113, the information processing unit 103 determines whether or not an instruction for power shutdown has been received from the operation unit 106. In a case where the determination result of the present step is Yes, the process proceeds to S114. In a case where the determination result of the present step is No, the process returns to S113. In S114, the information processing unit 103 reads the setting stored in S110 from the information storage unit 104, and returns the image capturing apparatus 100 to the setting before the function restriction.

As described above, in the present embodiment, drive stoppage of the lens apparatus 101 is controlled based on the information on the power supply apparatus 110 (e.g., the suppliable power value), the information on the lens apparatus 101 (e.g., the power consumption), and the information on the image capturing apparatus 100 (e.g., the power consumption). In a case where the drive of the lens apparatus 101 is stopped, the autofocus function (AF function) is disabled, and the manual focus assist function (MF assist function) is enabled. In other words, in a case where the supply power of the power supply apparatus 110 is insufficient with respect to the power consumption of the image capturing apparatus 100, the power consumption is suppressed by stopping power supply to the lens apparatus 101. In a case where the AF function of the image capturing apparatus 100 is enabled, the MF assist function is automatically enabled. As a result, usability in a case where the AF function is restricted can be improved.

### Second Embodiment

In the second embodiment, an example will be described in which, in an image capturing apparatus including a plurality of MF assist functions (e.g., a focus guide function, a peaking function, and the like), the MF assist function set in advance by the user is automatically enabled in a case where the AF function is restricted.

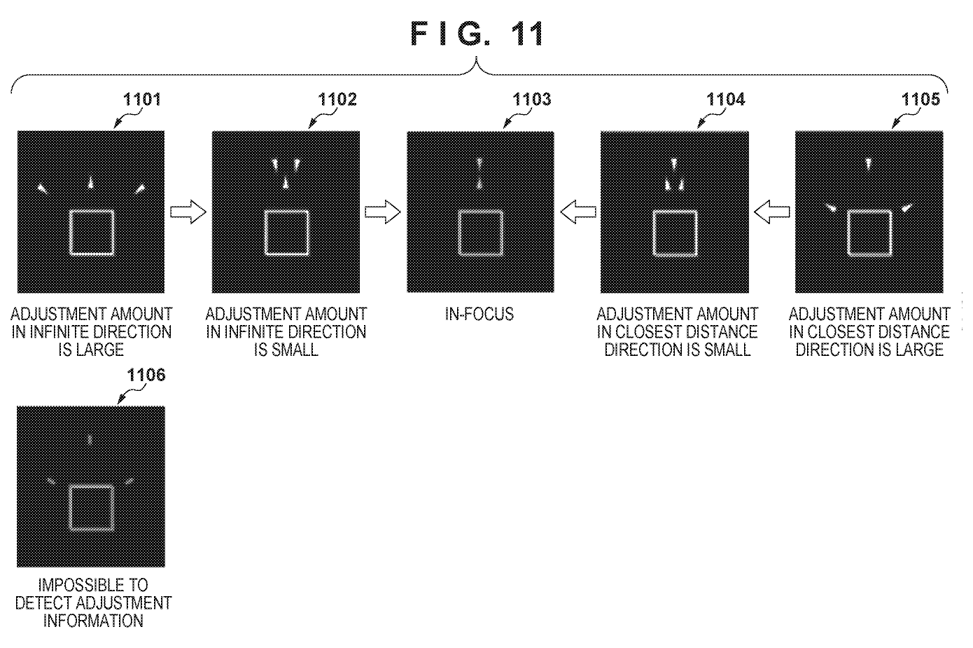

Here, an example of a focus guide function according to the present embodiment will be described with reference to FIG. 11. The focus guide function is a function of visually displaying, with a guide frame, an adjustment direction and an adjustment amount from a current focus position to a focusing position, and is a guide function for guiding to the focusing position by displaying various display forms corresponding to the current focus position. In FIG. 11, a display form 1101 represents that the adjustment amount in the infinite direction is large. A display form 1102 represents that the adjustment amount in the infinite direction is small. A display form 1103 represents that the focusing state is established. A display form 1104 represents that the adjustment amount in the closest distance direction is small. A display form 1105 represents that the adjustment amount in the closest distance direction is large. A display form 1106 represents that information for performing adjustment has not been detected. The user can perform adjustment for the purpose of the state of the display form 1103, which is the focusing state, while confirming these display forms.

### Configuration of Image Capturing Apparatus

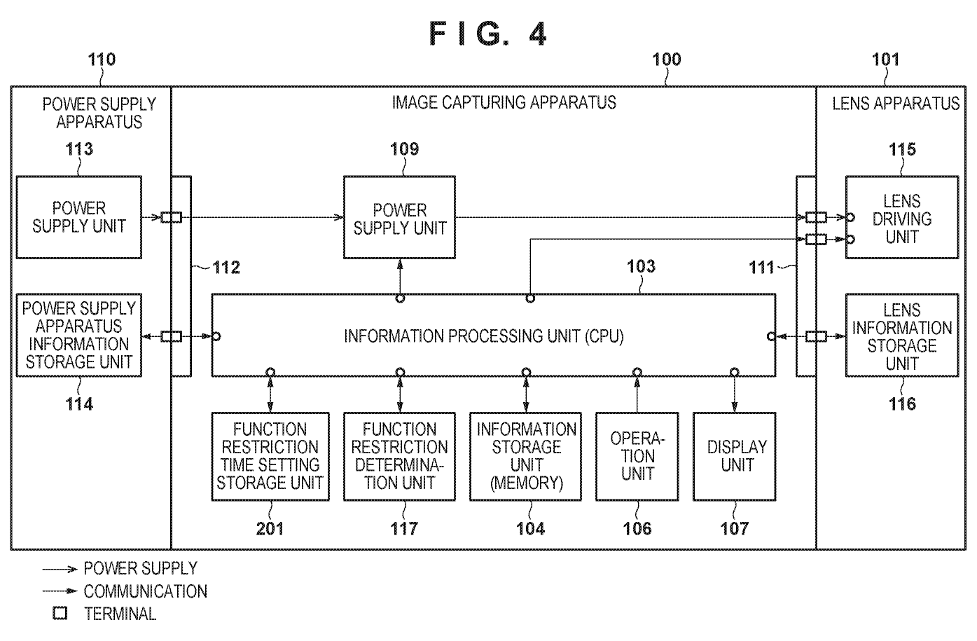

FIG. 4 is a block diagram for describing an example of components of the image capturing apparatus 100 in the second embodiment. Hereinafter, description for the same elements as those of the first embodiment will be omitted. A function restriction time setting storage unit 201 is, for example, a memory, and stores the MF assist function to be enabled by the image capturing apparatus 100 in a case where the function restriction determination unit 117 determines that function restriction is necessary. One or a plurality of MF assist functions may be stored in the function restriction time setting storage unit 201. The function restriction time setting storage unit 201 may be implemented in dedicated hardware or may be implemented as a part of the function of the information storage unit 104.

### Processing

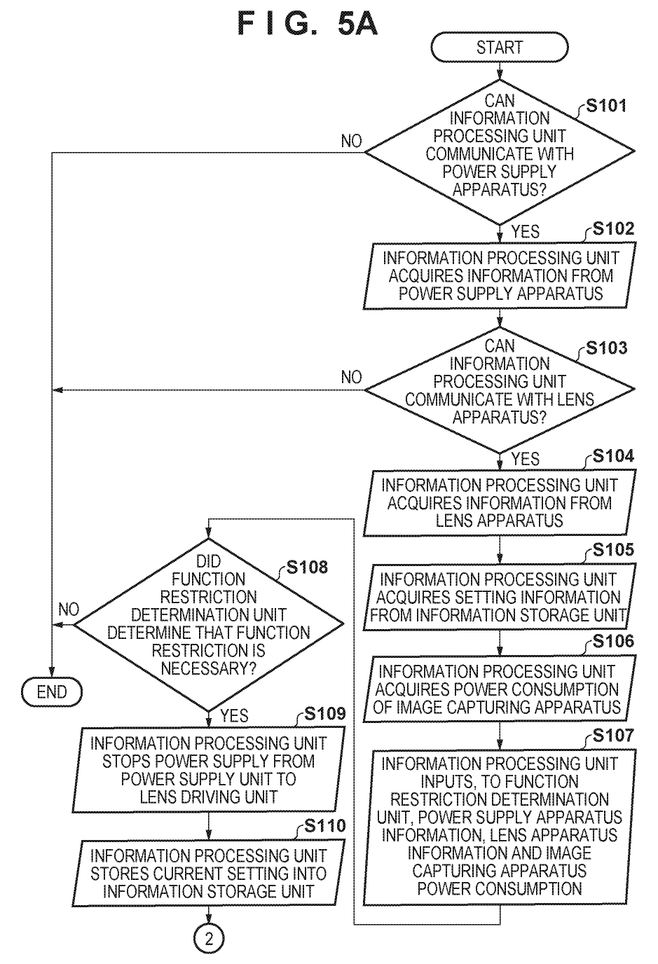

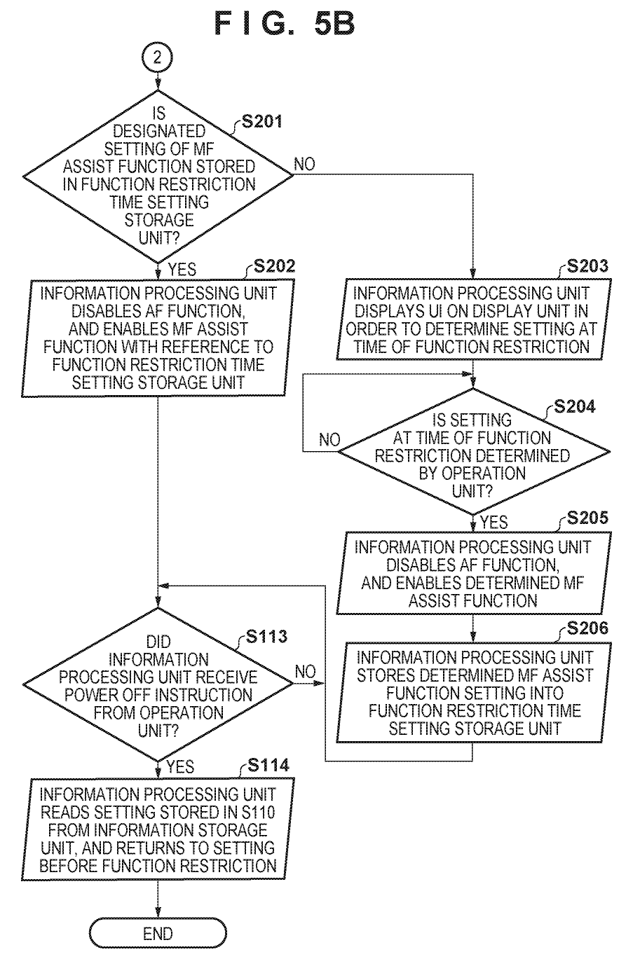

Subsequently, the procedure of the processing to be executed by the image capturing apparatus 100 according to the second embodiment will be described with reference to the flowchart of FIGS. 5A and 5B. The image capturing apparatus 100 in the second embodiment is controlled by the information processing unit 103. It is assumed that at the start of the present flowchart, the image capturing apparatus 100 is connected to the power supply apparatus 110 and the lens apparatus 101. Since the processing from S101 to S110 is the same as that in the first embodiment, the description will be omitted.

After the processing of S110, the information processing unit 103 determines in S201 whether or not information on a designated MF assist function is stored in the function restriction time setting storage unit 201. In a case where the determination result of the present step is Yes, the process proceeds to S202. In a case where the determination result of the present step is No, the process proceeds to S203.

In S202, the information processing unit 103 disables the AF function, and enables the MF assist function with reference to the information in the function restriction time setting storage unit 201. After completion of S202, the process proceeds to S113.

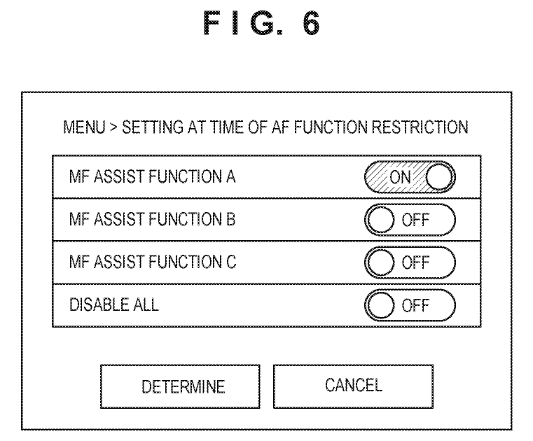

In S203, the information processing unit 103 displays a UI on the display unit 107 in order to cause the user to determine the setting of the MF assist function to be enabled at the time of function restriction. Here, FIG. 6 illustrates an example of the UI. In FIG. 6, a user interface screen (UI screen) regarding the setting at the time of AF function restriction, which is one of the menus, is displayed. The illustrated example is configured such that selection of on/off of the function can be received for each of the three types of MF assist functions (MF assist functions A to C). When it is desired to collectively disable all of the three types of MF assist functions, it is possible to collectively turn these off by selecting "disable all". The user operates these settings, and presses an "enter" button in a case of desiring to confirm the settings. On the other hand, in a case of desiring to cancel the screen of on/off control of the MF assist function to return to a menu screen, the user presses a "cancel" button.

In S204, the information processing unit 103 determines whether or not the setting of the MF assist function at the time of function restriction is determined by the operation unit 106. In a case where the determination result of the present step is Yes, the process proceeds to S205. In a case where the determination result of the present step is No, the process returns to S204. In S205, the information processing unit 103 disables the AF function, and enables the MF assist function determined in S204. In S206, the information processing unit 103 stores the setting of the MF assist function determined in S204 into the function restriction time setting storage unit 201. After completion of S206, the process proceeds to S113. Since the processing in S113 and thereafter is the same as that in the first embodiment, the description will be omitted.

As described above, in the present embodiment, in a case where the AF function is restricted in an image capturing apparatus including a plurality of MF assist functions (e.g., a focus guide function, a peaking function, and the like), the MF assist function desired by the user is automatically enabled. As a result, usability in a case where the AF function is restricted can be improved.

### Third Embodiment

In the third embodiment, an example will be described in which, in an image capturing apparatus including a plurality of MF assist functions (e.g., a focus guide function, a peaking function, and the like), the MF assist function is automatically enabled based on a use history of the user in a case where the AF function is restricted.

### Configuration of Image Capturing Apparatus

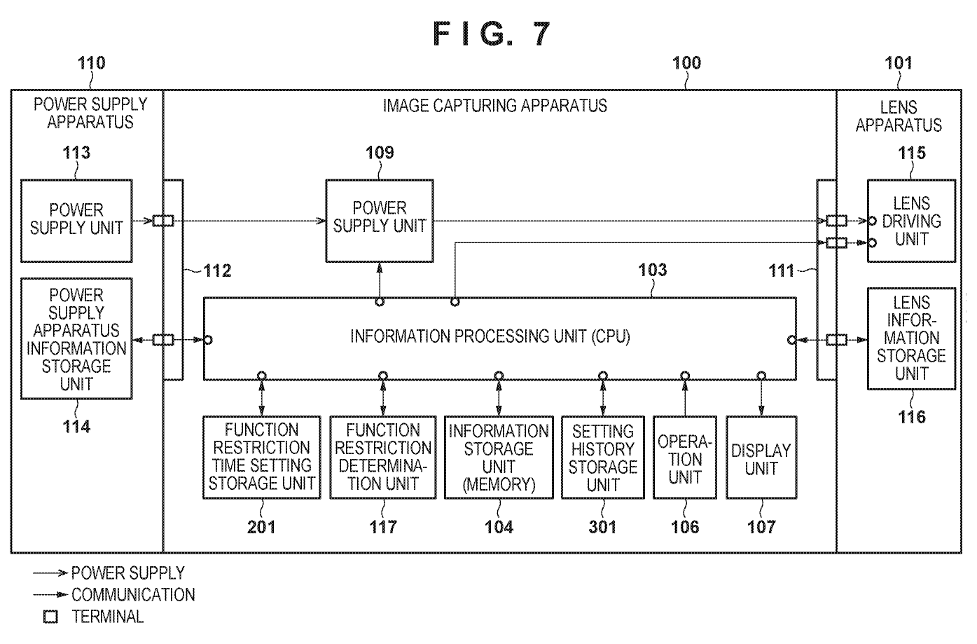

FIG. 7 is a block diagram for describing an example of components of the image capturing apparatus 100 in the third embodiment. Hereinafter, description for the same components as those of the first embodiment and the second embodiment will be omitted.

A setting history storage unit 301 is, for example, a memory, and stores the setting of the MF assist function in a case where the MF assist function is used in the image capturing apparatus 100. One or a plurality of MF assist functions may be stored in the setting history storage unit 301. The setting history storage unit 301 may be implemented in dedicated hardware or may be implemented as a part of the function of the information storage unit 104.

### Processing

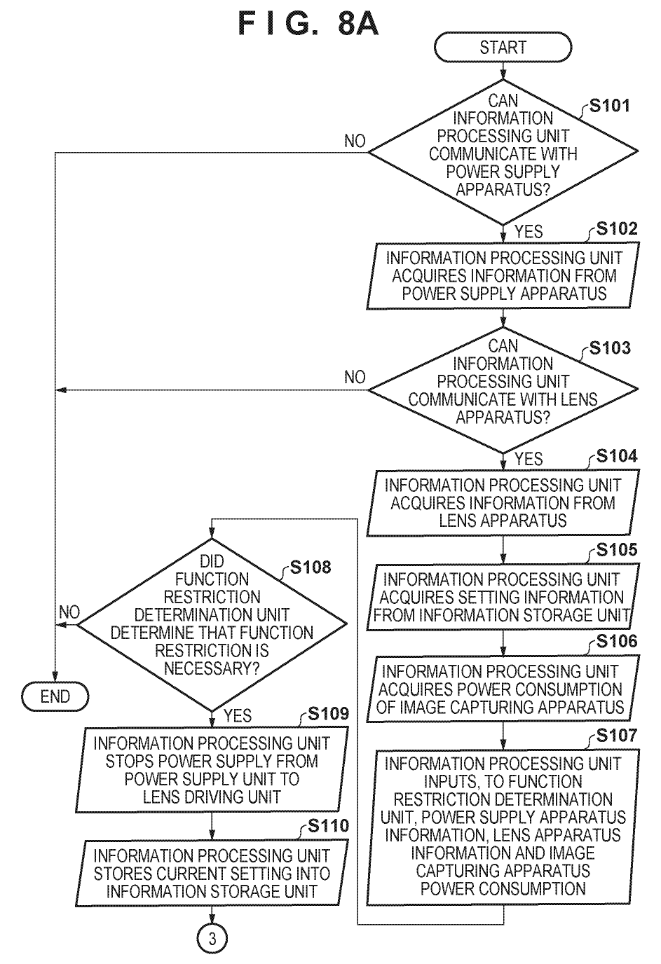

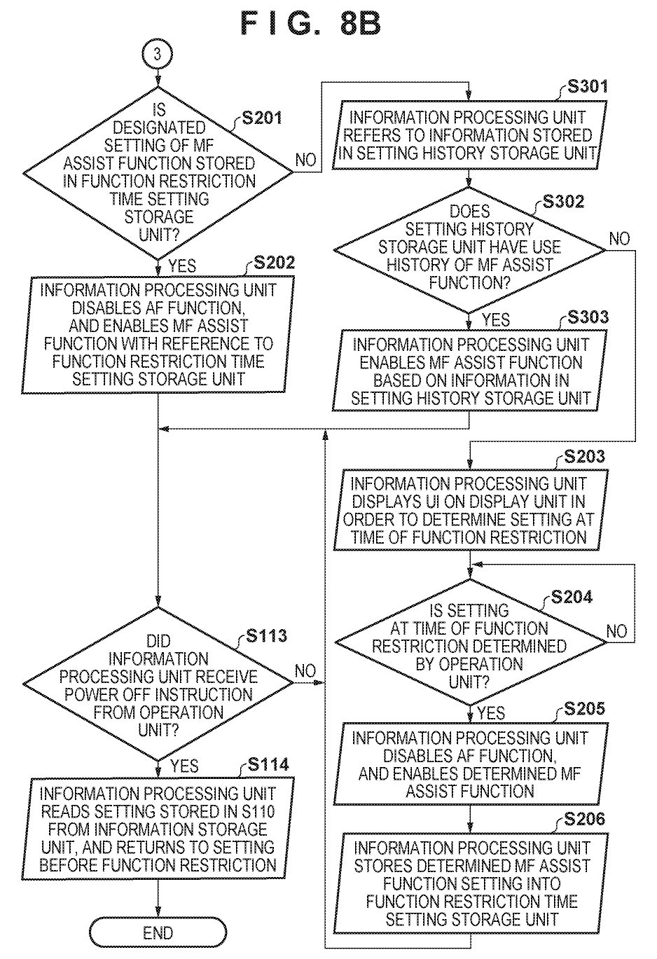

Subsequently, the procedure of the processing to be executed by the image capturing apparatus 100 according to the third embodiment will be described with reference to the flowchart of FIGS. 8A and 8B. The image capturing apparatus 100 in the third embodiment is controlled by the information processing unit 103. It is assumed that at the start of the present flowchart, the image capturing apparatus 100 is connected to the power supply apparatus 110 and the lens apparatus 101. Since the processing from S101 to S201 is the same as that in the second embodiment, the description will be omitted. In the present embodiment, in a case where the determination result in S201 is Yes, the process proceeds to S202. On the other hand, in a case where the determination result in S201 is No, the process proceeds to S301.

In S301, the information processing unit 103 refers to the information stored in the setting history storage unit 301. In S302, the information processing unit 103 determines whether or not the setting history storage unit 301 has a use history of the MF assist function. In a case where the determination result of the present step is Yes, the process proceeds to S303. In a case where the determination result of the present step is No, the process proceeds to S203.

In S303, the information processing unit 103 enables the MF assist function based on the information stored in the setting history storage unit 301. At this time, a recently used MF assist function may be enabled, or a most frequently used MF assist function may be enabled. For example, a most recently used MF assist function may be enabled, or an MF assist function used within a predetermined period from the current date and time may be enabled. An MF assist function that has been used a predetermined number of times or more may be enabled. Alternatively, one or more of these may be combined. After completion of S303, the process proceeds to S113. Since the processing in S113 and S203 and thereafter is the same as that in the second embodiment, the description will be omitted.

As described above, in the present embodiment, in a case where the AF function is restricted in an image capturing apparatus including a plurality of MF assist functions, the MF assist function is automatically enabled based on the use history of the user. As a result, usability in a case where the AF function is restricted can be improved.

### Fourth Embodiment

In the fourth embodiment, an example will be described in which, in an image capturing apparatus including a plurality of MF assist functions (e.g., a focus guide function, a peaking function, and the like), the MF assist function is automatically enabled based on a shooting mode of the image capturing apparatus in a case where the AF function is restricted.

### Configuration of Image Capturing Apparatus

A block diagram for describing an example of components of the image capturing apparatus 100 in the fourth embodiment is the same as that in FIG. 7. Hereinafter, description for the same elements as those of the third embodiment will be omitted.

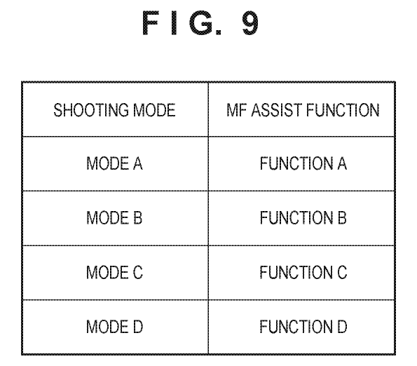

The function restriction time setting storage unit 201 according to the fourth embodiment can store the setting of the MF assist function corresponding to the shooting mode of the image capturing apparatus 100. The shooting mode is, for example, a still image shooting mode, a moving image shooting mode, or the like. Here, FIG. 9 is a schematic view illustrating an example of data to be stored in the function restriction time setting storage unit 201 in the fourth embodiment. The shooting mode includes four types of modes A to D, and the MF assist functions associated in advance with the modes are functions A to D, respectively.

### Processing

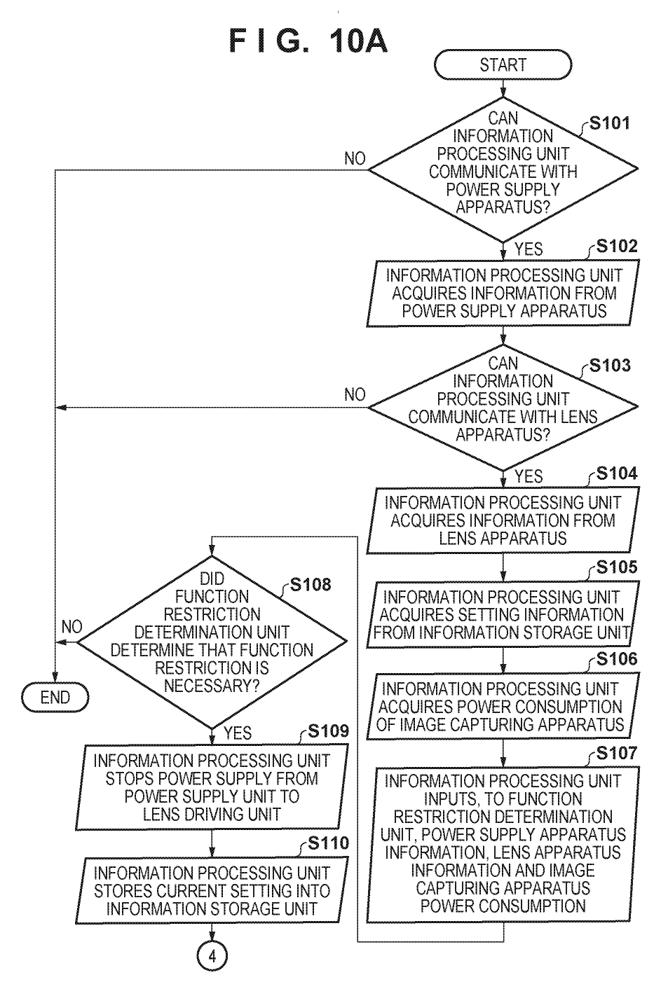

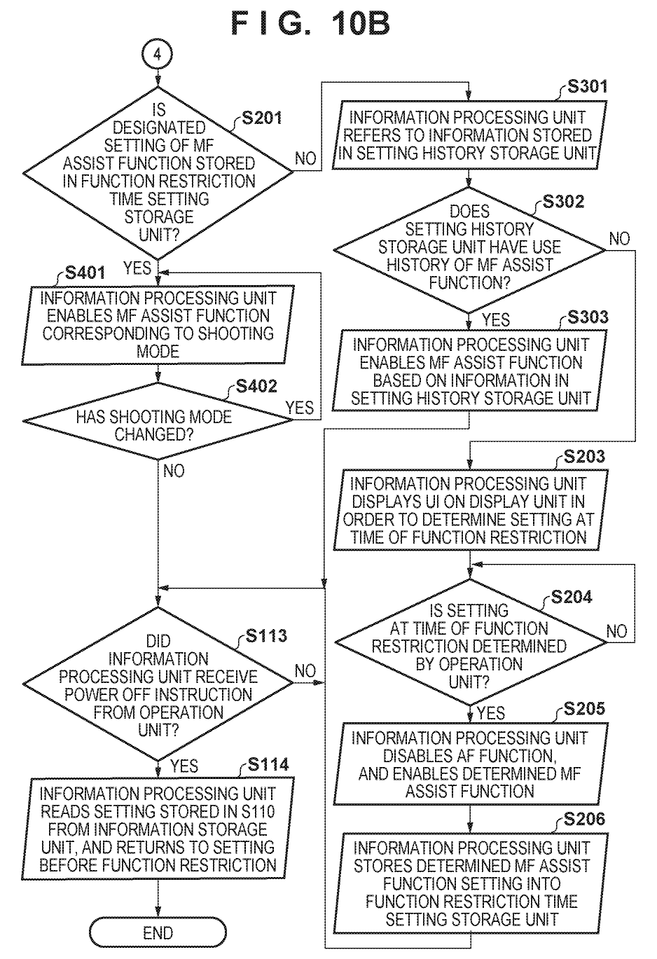

Next, a control method of the fourth embodiment to be performed by the image capturing apparatus 100 will be described with reference to the flowchart of FIGS. 10A and 10B. The image capturing apparatus 100 in the fourth embodiment is controlled by the information processing unit 103. It is assumed that at the start of the present flowchart, the image capturing apparatus 100 is connected to the power supply apparatus 110 and the lens apparatus 101. Since the processing from S101 to S201 is the same as that in the third embodiment, the description will be omitted. In the present embodiment, in a case where the determination result in S201 is Yes, the process proceeds to S401. On the other hand, in a case where the determination result in S201 is No, the process proceeds to S301.

In S401, with reference to the information in the function restriction time setting storage unit 201, the information processing unit 103 enables the MF assist function set corresponding to the shooting mode. Note that the information on the shooting mode may be acquired in advance or may be acquired in S401.

In S402, the information processing unit 103 determines whether or not the shooting mode of the image capturing apparatus 100 has been changed after activation. In a case where the determination result of the present step is Yes, the process returns to S401. In a case where the determination result of the present step is No, the process proceeds to S113. Since the processing in S113 and S301 and thereafter is the same as that in the third embodiment, the description will be omitted.

As described above, in the present embodiment, in a case where the AF function is restricted in an image capturing apparatus including a plurality of shooting modes and a plurality of MF assist functions, the MF assist function is automatically enabled based on the shooting mode of the image capturing apparatus. As a result, usability in a case where the AF function is restricted can be improved.

According to the present disclosure, usability can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-004338, filed January 10, 2025, which is hereby incorporated by reference herein in its entirety.

What is claimed is:

1. An image capturing apparatus connectable to a power supply apparatus, comprising:
one or more memories storing instructions; and
one or more processors configured to execute the instructions to:
disable an autofocus function and enable a manual focus assist function for assisting confirmation of a focusing state at a time of manual focus adjustment, based on information on the power supply apparatus.

2. The image capturing apparatus according to claim 1,
wherein the image capturing apparatus is connectable to a lens apparatus, and
wherein the one or more processors further execute the instructions to:
control drive stoppage of the lens apparatus based on the information on the power supply apparatus; and
disable an autofocus function and enable a manual focus assist function for assisting confirmation of a focusing state at a time of manual focus adjustment, in a case where drive of the lens apparatus is stopped.

3. The image capturing apparatus according to claim 2,
wherein the one or more processors further execute the instructions to:
control drive stoppage of the lens apparatus based on information on the power supply apparatus, information on the lens apparatus, and information on the image capturing apparatus.

4. The image capturing apparatus according to claim 3,
wherein the information on the power supply apparatus is a suppliable power value of the power supply apparatus,
the information on the lens apparatus is a power consumption of the lens apparatus, and
the information on the image capturing apparatus is a power consumption of the image capturing apparatus.

5. The image capturing apparatus according to claim 4,
wherein the one or more processors further execute the instructions to:
determine whether or not function restriction is necessary based on a suppliable power value of the power supply apparatus, a power consumption of the lens apparatus, and a power consumption of the image capturing apparatus, and
stop drive of the lens apparatus in a case where it is determined that the function restriction is necessary.

6. The image capturing apparatus according to claim 5,
wherein the one or more processors further execute the instructions to:
disable the autofocus function and enable the manual focus assist function, in a case where the autofocus function is enabled when it is determined that the function restriction is necessary.

7. The image capturing apparatus according to claim 5,
wherein the one or more processors further execute the instructions to:
determine that the function restriction is necessary in a case where a sum of the power consumption of the lens apparatus and the power consumption of the image capturing apparatus is larger than the suppliable power value of the power supply apparatus.

8. The image capturing apparatus according to claim 2,
wherein the one or more processors further execute the instructions to:
cause a user to select whether to enable the manual focus assist function in response to drive of the lens apparatus being stopped, and enable the manual focus assist function in a case where enabling of the manual focus assist function is selected.

9. The image capturing apparatus according to claim 5,
wherein the one or more processors further execute the instructions to:
store, into the one or more memories, a setting of a manual focus assist function to be enabled in a case where it is determined that the function restriction is necessary, and enable the manual focus assist function stored in the one or more memories.

10. The image capturing apparatus according to claim 5,
wherein the one or more processors further execute the instructions to:
display a user interface screen for receiving a setting of a manual focus assist function to be enabled in a case where it is determined that the function restriction is necessary; and
enable the manual focus assist function set via the user interface screen, in a case where the setting is received.

11. The image capturing apparatus according to claim 1,
wherein the one or more processors further execute the instructions to:
store a use history of one or more manual focus assist functions into the one or more memories, and
enable a manual focus assist function based on the use history.

12. The image capturing apparatus according to claim 11,
wherein the one or more processors further execute the instructions to:
enable a most recently used manual focus assist function.

13. The image capturing apparatus according to claim 11,
wherein the one or more processors further execute the instructions to:
enable a manual focus assist function whose number of uses is a predetermined number of times or more.

14. The image capturing apparatus according to claim 11,
wherein the one or more processors further execute the instructions to:
enable a most frequently used manual focus assist function.

15. The image capturing apparatus according to claim 1,
wherein the one or more processors further execute the instructions to:
enable a manual focus assist function associated with a shooting mode of the image capturing apparatus.

16. The image capturing apparatus according to claim 1, wherein the manual focus assist function includes at least one of a focus guide function and a peaking function that highlights a contour of a focusing position.

17. The image capturing apparatus according to claim 2 further comprising:
a power supply unit; and
a lens drive unit that drives the lens apparatus,
wherein the one or more processors further execute the instructions to:
stop drive of the lens apparatus by stopping power supply from the power supply unit to the lens drive unit.

18. A control method of an image capturing apparatus connectable to a power supply apparatus, the control method comprising:
disabling an autofocus function and enabling a manual focus assist function for assisting confirmation of a focusing state at a time of manual focus adjustment, based on information on the power supply apparatus.

19. A non-transitory computer-readable storage medium storing a program for causing a computer to execute a control method of an image capturing apparatus connectable to a power supply apparatus, the control method including
disabling an autofocus function and enabling a manual focus assist function for assisting confirmation of a focusing state at a time of manual focus adjustment, based on information on the power supply apparatus.
